(19) United States
(12) Patent Application Publication
(10) Pub. No.: US 2011/0272830 A1
(43) Pub. Date: Nov. 10, 2011

(54) DOWNCOMERS FOR MASS TRANSFER COLUMN

(75) Inventors: Frank Buerstinghaus, Houston, TX (US); Kevin M. Kelleher, Houston, TX (US); David Shaye, Houston, TX (US)

(73) Assignee: Bayer MaterialScience LLC, Pittsburgh, PA (US)

(21) Appl. No.: 13/100,507

(22) Filed: May 4, 2011

Related U.S. Application Data
(60) Provisional application No. 61/332,333, filed on May 7, 2010.

(51) Int. Cl. B01J 19/32; B01D 3/22; B01F 3/04

(52) U.S. Cl. 261/114.5

(57) ABSTRACT

The present disclosure is directed to an improved mass-transfer column, the column comprising a plurality of trays and associated downcomers, wherein at least one of the downcomers comprises an upstream and downstream end, as defined by the direction of flow of liquid through the column, the upstream and downstream end each having an opening defined by a plurality of walls, wherein each of the walls extend substantially entirely between the upstream opening and the downstream opening, and wherein at least one of the walls has at least two sections, a first section of the wall forming an angle α with a plane parallel to the associated tray, and a second section of the wall, which forms an angle β with a plane parallel to the associated tray, wherein said second section is downstream from the first section, and α<β.

### TECHNICAL FIELD

The present disclosure is directed to an improved design for downcomers used in mass transfer columns.

### BACKGROUND

Mass transfer columns, for example, distillation columns, typically comprise a plurality of trays through or over which gas and liquid material passes. In general the trays are circular in shape and aligned such that the largest surface is horizontal. Generally vapor or gas will flow upwards through the column and the internal trays, while liquid will flow down through the column.

In some cases, downcomers are used to transfer liquid from one tray to the adjacent tray below. Downcomers effectively act as funnels to transfer the liquid passing through the column from top to bottom. The liquid flows down through the downcomer, to the adjacent tray below, where it contacts the vapor flowing up through the tray. The liquid flows over the tray to the associated downcomer, and flows through the downcomer. This process is repeated until the liquid reaches the bottom of the column.

Traditionally downcomers are attached to or integrated with an associated tray. In this way, the upstream opening of the downcomer forms an opening in the associated tray. FIG. 1 illustrates a typical tray and downcomer assembly. As can be seen, one type of downcomer has a generally trapezoidal cross-sectional shape. However, when used in some special mass-transfer columns such as a dephosgenation column, the downcomer illustrated in FIG. 1 can experience fouling as evidenced by solid deposits at the downstream opening of the downcomer.

### SUMMARY

One embodiment of the present invention is directed to an improved mass-transfer column, the column comprising a plurality of trays and associated downcomers, wherein at least one of the downcomers comprises an upstream and downstream end, as defined by the direction of flow of liquid through the column, the upstream and downstream end each having an opening defined by a plurality of walls, wherein each of the walls extend substantially entirely between the upstream opening and the downstream opening, and wherein at least one of the walls has at least two sections, a first section of the wall forming an angle α with a plane parallel to the associated tray, and a second section of the wall, which forms an angle β with a plane parallel to the associated tray, wherein said second section is downstream from the first section, and α<β.

It is understood that the invention is not limited to the embodiments disclosed in this Summary, and is intended to cover modifications that are within the spirit and scope of the invention as defined by the claims.

### BRIEF DESCRIPTION OF THE DRAWINGS

The characteristics and advantages of the present disclosure may be better understood by reference to the accompanying figures, in which:

FIG. 1 is a top view of a conventional tray and integrated downcomer;

FIG. 2 is a cross-sectional view of the conventional tray and integrated downcomer of FIG. 1 along plane b-b;

FIG. 3 is a cross-sectional view of the conventional tray and integrated downcomer of FIG. 1 along plane a-a;

FIG. 4 is a top view of a tray and integrated downcomer according to one embodiment of the present invention;

FIG. 5 is a cross-sectional view of the tray and integrated downcomer of FIG. 4 along plane b-b;

FIG. 6a is a cross-sectional view of the tray and integrated downcomer of FIG. 4 along plane a-a;

FIG. 6b is the cross-sectional view of the tray and integrated downcomer of FIG. 4 along plane a-a shown in FIG. 6a, but rotated 90 degrees.

FIG. 7 is a fabricator's drawings for a tray and integrated downcomer according to the present invention.

### DETAILED DESCRIPTION

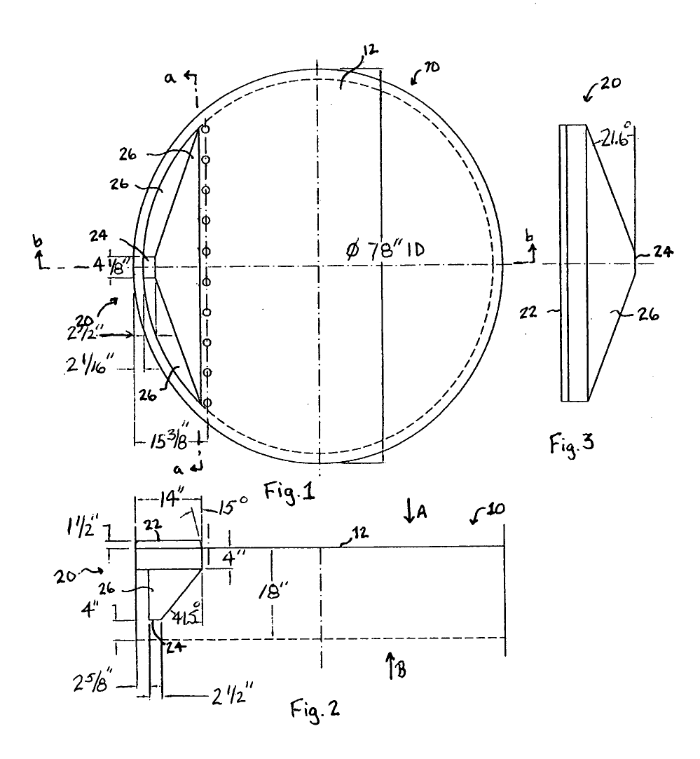

Referring to FIGS. 1-3, shown is a conventional assembly 10 comprising a tray 12 with an integrated downcomer 20 utilized in mass-transfer columns. Liquid flows in the direction A, while vapor flows generally in the direction B. The downcomer 20 has an upstream end and downstream end, as defined by the direction of flow of liquid through the column. The upstream end has an upstream opening 22 and the downstream end has a downstream opening 24, each defined by a plurality of walls 26. The walls 26 are angled to form a substantially trapezoidal shape. For the traditional downcomer 20, the walls 26 are oriented such that they form an angle with a plane parallel to the tray 12, and the angle is constant along the length of wall 26.

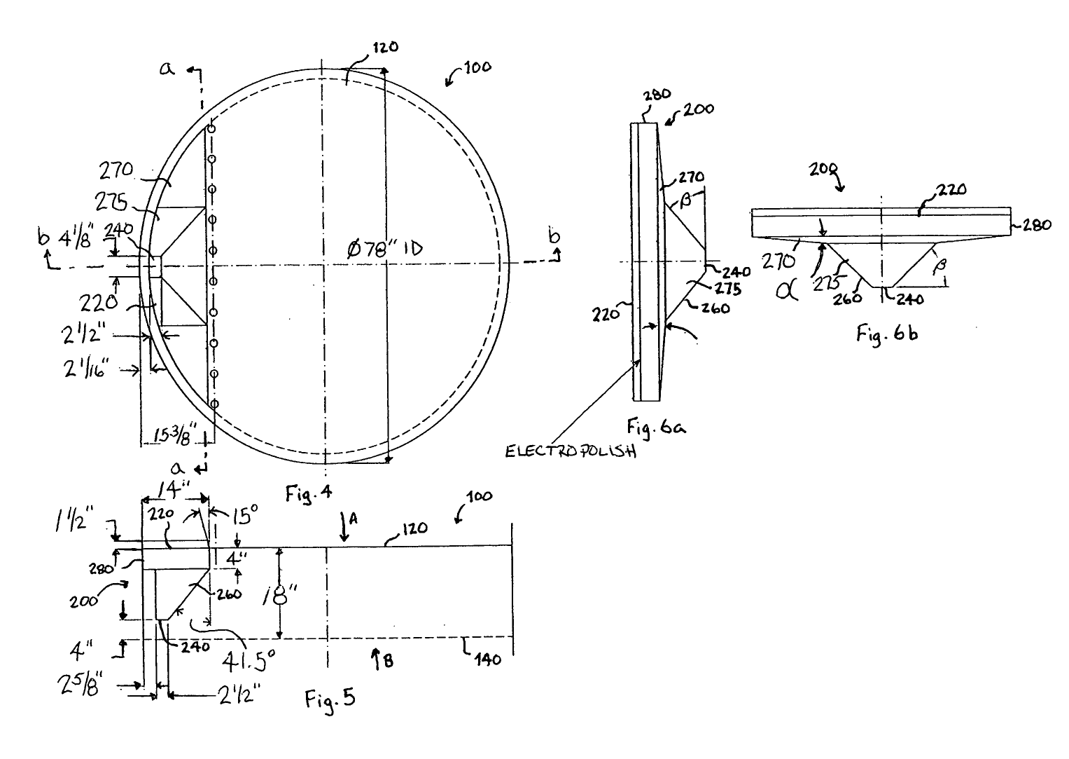

Referring now to FIGS. 4, 5, 6a and 6b, shown is an assembly 100 according to the present invention comprising a tray 120 with an integrated downcomer 200 utilized in mass-transfer columns. Liquid flows in the direction A, while vapor flows generally in the direction B. The downcomer 200 has an upstream end and downstream end, as defined by the direction of flow of liquid through the column. The upstream end has an upstream opening 220 and the downstream end has a downstream opening 240, each defined by a plurality of walls 260. The walls 260 are angled to form a substantially trapezoidal shape. At least one of the walls 260 has at least two sections. A first section 270 of the wall 260 forms an angle α with a plane parallel to the associated tray 120. A second section 275 of the wall 260, forms an angle β with a plane parallel to the associated tray 120. The second section 275 is downstream from the first section 270, and α<β. This means the walls 260 are generally angled inward toward the flow of liquid through the downcomer. It also means the area of outlet 240 will be smaller than the area of inlet 220.

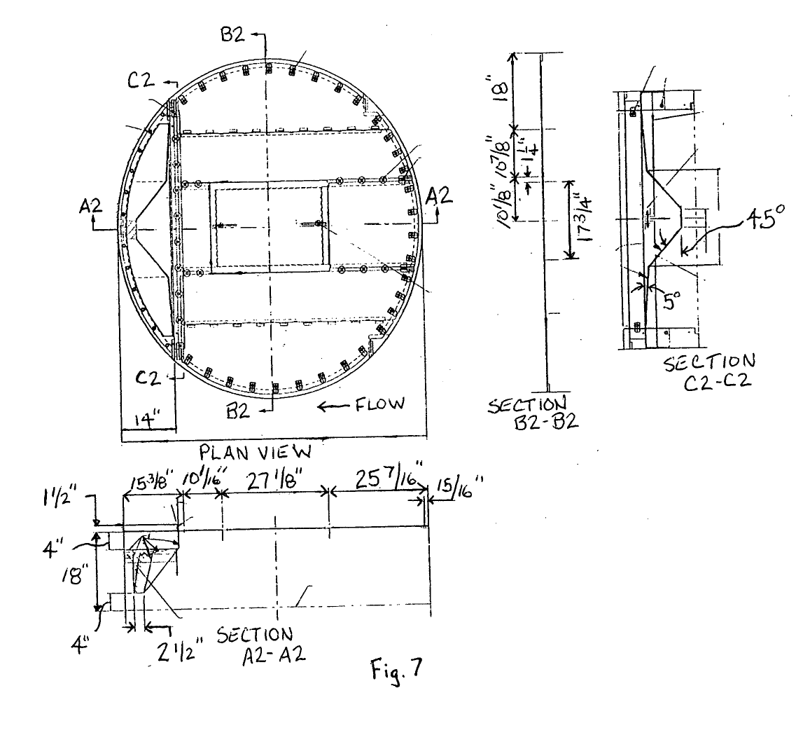

In one alternate embodiment, α is from about 1° to about 20°, preferably about 2° to about 15°, more preferably about 3° to about 10°, more preferably about 3° to about 6°. In the embodiment shown in FIG. 7, α is 5°. In a further embodiment, β is from about 30° to about 90°, more preferably 35° to 60°, more preferably 40° to 50°. In the embodiment illustrated in FIG. 7, β is 42.4°.

In one alternate embodiment, the ratio of β:α is from 1.1 to 50, more preferably 1.5 to 40, more preferably 2 to 20, more preferably 3 to 10. In the embodiment shown in FIG. 7, the ratio of β:α is 8.48.

In an alternate embodiment, the walls 260 further comprise a third section 280, which is upstream from the first section 270. Preferably, the third section 280 forms a right angle with a plane parallel to the associated tray 120. Alternatively, the third section 280 forms more than or less than a right angle with a plane parallel to the associated tray 120.

One skilled in the art will appreciate the downcomers will be made of material which can withstand the pressure and temperature of the particular mass transfer process, as well as the corrosive nature of any liquids and vapors used in the particular mass transfer process. In some embodiments, it is advantageous for the surfaces of the trays 120 and downcomers 200 to have surfaces which contact the liquid which are polished, preferably electropolished.

One skilled in the art will appreciate the particular arrangement of the mass transfer column will depend upon the nature of the materials to be utilized in the process. Particular sizes of the trays and downcomers, as well as their numbers and spacing, as well as other parameters, will depend on the mass flow through the column, the temperature and pressure in the column, and the physical properties of the compounds which make up the liquid and vapor. In one particular embodiment, the downcomers described herein find particular utility in a dephosgenation column. In this particular embodiment, the downcomers of the present invention have significantly reduced the amount of deposits found within the downcomers relative to conventional downcomers.

The present invention has been described with reference to certain exemplary and illustrative embodiments. However, it will be recognized by persons having ordinary skill in the art that various substitutions, modifications or combinations of any of the exemplary embodiments (or portions thereof) may be made without departing from the scope of the invention. Thus, the invention is not limited by the description of the exemplary and illustrative embodiments, but rather by the claims.

What is claimed is:

1. An improved mass-transfer column, the column comprising a plurality of trays and associated downcomers, wherein at least one of the downcomers comprises an upstream and downstream end, as defined by the direction of flow of liquid through the column, the upstream and downstream end each having an opening defined by a plurality of walls, wherein each of the walls extend substantially entirely between the upstream opening and the downstream opening, and wherein at least one of the walls has at least two sections, a first section of the wall forming an angle α with a plane parallel to the associated tray, and a second section of the wall, which forms an angle β with a plane parallel to the associated tray, wherein said second section is downstream from the first section, and α<β.

2. The column of claim 1, wherein the ratio of β:α is at least 2:1.
